(19) United States
(12) Patent Application Publication
(10) Pub. No.: US 2025/0144659 A1
(43) Pub. Date: May 8, 2025

(54) SMART IRRIGATION SYSTEM

(71) Applicants: Hans Klein, Bonsall, CA (US); Oleksandr Karpin, Lviv (UA); Oleksandr Hostanar, Lviv (UA)

(72) Inventors: Hans Klein, Bonsall, CA (US); Oleksandr Karpin, Lviv (UA); Oleksandr Hostanar, Lviv (UA)

(21) Appl. No.: 18/386,730

(22) Filed: Nov. 3, 2023

(51) Int. Cl. B05B 15/74; A01G 25/16; F03B 17/06

(52) U.S. Cl. CPC B05B 15/74; A01G 25/16; F03B 17/06

(57) ABSTRACT

A smart irrigation system is described. The irrigation system includes a controller as well as a number of in-line elements for distributing water and/or making measurements related to irrigation of an area.

### TECHNICAL FIELD

This disclosure relates to the field of irrigation systems, particularly the control, communication, and power of distributed water distribution mechanisms.

### BACKGROUND

Irrigation systems are becoming increasing complex as the needs for water and the concerns regarding waste become greater. Control of water distribution throughout an irrigation system creates unique challenges as power and communication must be provided in a system that is exposed to the elements, is often buried, and is subject to potential impact and saturation. What is needed is a system and apparatus for providing control signals, processing, and power that is scalable, easy to install, and available for after-market changes.

### BRIEF DESCRIPTION OF THE DRAWINGS

FIG. 1 illustrates an irrigation system for communication with irrigation elements, according to an embodiment.

FIG. 2A illustrates RF communication between an irrigation controller and a smart sprinkler, according to an embodiment.

FIG. 2B illustrates a layout of a residential landscape, including irrigation zones, according to an embodiment.

FIG. 2C illustrates placement of smart irrigation system elements for a residential landscape, according to an embodiment.

FIG. 2D illustrates a mesh network from irrigation system elements for a residential landscape, according to an embodiment.

FIG. 2E illustrates irrigation system elements for a residential landscape, according to an embodiment.

FIG. 3A illustrates wireless communication between an irrigation controller and a smart sprinkler, according to an embodiment.

FIG. 3B illustrates a system for hydroacoustic communication between an irrigation controller and a smart sprinkler, according to an embodiment.

FIG. 3C illustrates a system for galvanic communication between an irrigation controller and a smart sprinkler, according to an embodiment.

FIG. 4 illustrates a communication and control system for a smart, self-controlled sprinkler, according to an embodiment.

FIG. 5A illustrates an embodiment of a sprinkler head including communication, control, and energy harvesting elements.

FIG. 5B illustrates a conceptual implementation of a sprinkler head with energy harvesting elements.

FIGS. 6A and 6B illustrate energy harvesting circuits for use in a smart sprinkler or in-line element, according to an embodiment.

FIG. 7 illustrates an embodiment of a magnetic yoke for use in energy harvesting.

FIG. 8 illustrates an embodiment of an impeller for use in energy harvesting.

FIG. 9 illustrates an embodiment of an impeller, permanent magnets, and supports for use in energy harvesting.

FIG. 10 illustrates an embodiment of shaped impeller blades and a water guide for use in energy harvesting.

FIG. 11 illustrates an embodiment of shaped impeller blades for use in energy harvesting.

FIG. 12 illustrates an embodiment of shaped impeller blades for use in energy harvesting.

FIG. 13 illustrates an embodiment of an impeller with a permanent magnet not disposed directly thereon.

FIG. 14 illustrates an embodiment of method for operating a smart sprinkler in an irrigation system.

FIG. 15 illustrates an embodiment of method for operating a smart sprinkler in an irrigation system.

FIG. 16 illustrates an embodiment of method for operating a smart sprinkler in an irrigation system with multiple controllers.

### DETAILED DESCRIPTION

The following description sets forth numerous specific details such as examples of specific systems, components, methods, and so forth, in order to provide a good understanding of various embodiments of the communication schemes and techniques. It will be apparent to one skilled in the art, however, that at least some embodiments may be practiced without these specific details. In other instances, well-known components or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention. References in the description to “an embodiment”, “one embodiment”, “an example embodiment”, “some embodiments”, and “various embodiments” mean that the particular feature, structure, or characteristic being referred to is included in at least one embodiment of the invention. Further, the appearances of the phrases “an embodiment”, “one embodiment”, “an example embodiment”, “some embodiments”, and “various embodiments” in various places in the description do not necessarily all refer to the same embodiment(s).

In various embodiments, the communication schemes and techniques described herein may comprise one or more methods that are executed by one or more devices and/or controllers thereof. Although the operations of such method(s) are shown and described hereinafter in a particular order, the operations of each method may be altered so that certain operations may be performed in a different order or so that certain operation(s) may be performed, at least in part, concurrently and/or in parallel with other operations. In other embodiments, instructions or sub-operations of distinct operations may be executed in an intermittent and/or alternating manner. Thus, the various method embodiments of the described techniques, as well as the order of operations therein, are to be regarded in an illustrative rather than a restrictive sense.

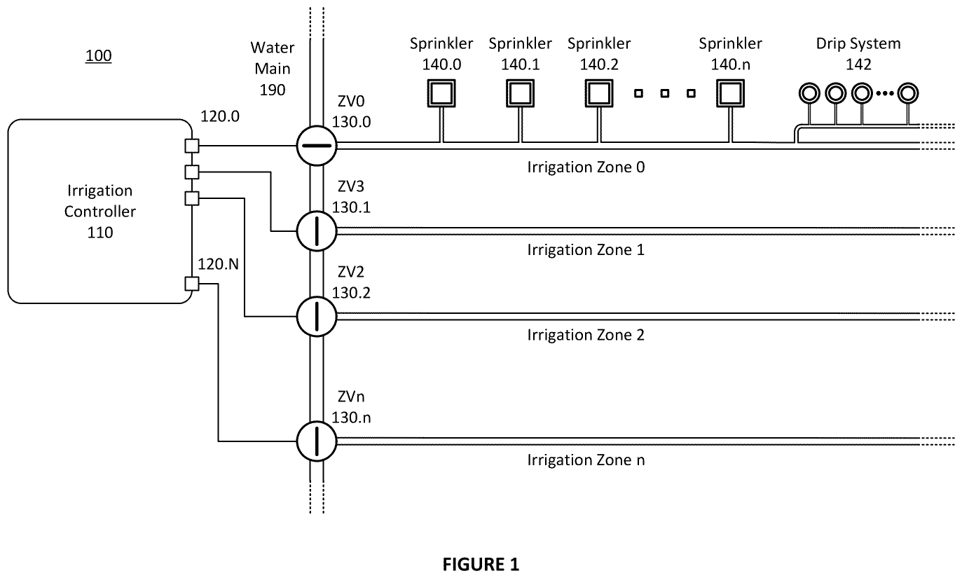

FIG. 1 illustrates an irrigation system 100 with zone control. Irrigation system 100 may include an irrigation controller 110 with a number of inputs/outputs (IOs) 120.0-120.n to provide control signals to a number of zone valves 130.0-130.n. Zone valves 130.0-130.n may couple irrigation zones 0-N to water main 190 such that their opening and closing controls the distribution of water to various areas of irrigation system 100. In one embodiment, irrigation zone 0 may include a number of sprinklers 140.0-140.n and a drip system 142. Irrigation zone 1 may include a similar makeup of sprinklers and drip systems or it may be different, depending on the needs of an area covered by irrigation zone 1. Similarly, irrigations zones 2-n may similar or different, depending on the system requirements.

With zone-level control, when irrigation system 110 provides control signals to zone valves 130.0-130.n, water from water main 190 may be routed into the individual zones (when the valve is open) or it may be blocked (when the valve is closed). For embodiments with more localized control, irrigation system 110 may provide control signals to individual sprinklers (140.0-140.n) or to drip system 142. In this embodiment, water distribution may be routed only through sprinklers or drip systems corresponding or assigned to areas that require it. In still another embodiment, a combination of zone control and sprinkler control may be implemented. In this embodiment, zone valves 130.0-130.n may be opened for coarse level control of water and sprinklers 140.0-140.n (and each set of sprinklers and drips systems associated with other irrigation zones) may be further controlled to refine water usage.

Zone valves 130.0-130.n, sprinklers 140.0-140.n, and drip system 142 (as well as similar sprinklers and drip systems associated with other irrigation zones) may have individually addressable receivers that are responsive to communication and control signals from irrigation system 110. In this way specific instructions may be provided to specific locations with the area covered by irrigation system 100 to tailor water distribution to the needs of those specific locations (either increased or decreased irrigation) and to respond to fault conditions (e.g., broken sprinklers that release too much water or clogged sprinklers that release too little water).

Irrigation system 110 may be a dedicated controller with exclusive control over irrigation system 100. In other embodiments, however, irrigation system 110 may be a personal computing device, such as a personal computer, handheld device (e.g., a smartphone or a tablet computer), or a plug-in device for smart television. In these embodiments, irrigation system 110 may run dedicated software (for personal computers) or an application (for handheld devices or plug-in devices). Irrigation controller may also run as a internet-based interface on any of the aforementioned devices.

Zone valves 130.0-130.n, sprinklers 140.0-140.n, or drip system 142, when in operative communication with irrigation controller 110, may transmit a variety of data about irrigation system 100 to irrigation controller 110. Such information may include data on actual flow rate, the volume of water released, the status of each sprinkler, zone valve, or drip system, and any faults in the system or for specific elements. Status of sprinklers and other system elements may be active, inactive, faulty, etc. Using this information, irrigation system 110 may provide control signals to turn off (or otherwise reduce the flow of water to) one or more specific zones, sprinklers, or drip systems. In such an embodiment, a zone may be “enabled”, providing a maximum amount of water for each sprinkler in the zone. But as various conditions are detected and/or met, sprinklers may be “disabled”, thus reducing total water use for irrigation system 100 to only that which is required for the area serviced by irrigation system elements.

In one embodiment, sensors that are not directly linked to sprinklers or drip systems may be used. These sensors may include in-ground temperature sensors, moisture sensors, or humidity sensors. In other embodiments, weather stations capable of measuring and reporting atmospheric conditions such as humidity, barometric pressure, precipitation air temperature, light intensity, particulates, wind speed, etc. may be in operative communication with an irrigation controller 110. Additional sensors specific to operation of a sprinkler may include water pressure and sprinkler head extension (along the z-axis) and may communicate such information to irrigation controller 110. In the various embodiments, irrigation system 100 may receive data from temperature sensors, moisture sensors, humidity sensors, or other sensors communicatively coupled to irrigation system 100 to inform decision-making on water distribution and further refine and optimize watering for irrigation system 100.

As previously stated, sprinklers (or other irrigation outlets or in-line modules, such as valves) can transmit status information to irrigation system 110. But in response to this information, irrigation system 110 may provide control signals to sprinklers 140-0-140.N to take specific actions. Specific actions may be to shut off a sprinkler or zone with unusual or increased flow rates or to otherwise change the prescribed irrigation pattern.

Irrigation controller 110 may also provide alerts to maintenance facilities or personnel or to homeowners (in cases where irrigation system 100 is implemented in a residential application). These alerts may be electronic communications, such as an electronic mail (e-mail) or a text message. Alerts may also be notifications in an application or the aforementioned software interface. In still another embodiment, the alert may be a push notification sent through a handheld device. In such embodiments, important status updates may be passed to parties charged with the maintenance or control of irrigation system 100 quickly so that appropriate action may be taken with minimal delay and reduced impact to irrigation system 100 and to areas serviced by irrigation system 100. Impacts may be extra water use, damaged agriculture (from too much or too little irrigation), or damaged infrastructure.

Additionally, irrigation system 110 may take the information provided from sprinklers and sensors to collect statistics on water use and its effects for greater intelligence for irrigation control as well as for supporting report generation. Information and statistics may include real-time detection of broken sprinklers and fault conditions. Irrigation controller, an interface device, a user, or a cloud-based processor may initiate corrective action for fault conditions. Because a sprinkler has a specific identification that may be tied to a specific location within irrigation system 100, the location of the fault may be known with precision, reducing the time required to located and repair faulty elements. Information and statistics that may be measured and reported may include water pressure in the system. In this embodiment, a sudden or unexpected drop in water pressure may indicate a fault that is not directed tied to a sprinkler or drip system. This may occur if a pipe or other element is damaged, causing a rupture. In one embodiment, sprinklers may report the level of extension of each of their risers, or merely that a riser did not fully extend. In this embodiment, a riser that is not fully extended may lead to poor coverage and areas that are not properly irrigated.

Communication between irrigation system 110 and various elements of irrigation system 100 may be wired, RF-based, galvanically coupled, or acoustic/hydro-acoustic. While wired communication is feasible, the cost for retrofitting existing irrigation systems as well as the installation of new irrigation systems may prove prohibitive. Instead, wireless methods may provide easier installation for both existing and new irrigation systems. RF-based systems may use wireless protocols such as Bluetooth or Bluetooth Low-Energy (BLE), Wi-Fi, or Ultra-Wideband (UWB). Galvanically coupled communication may use the water's conductivity. And acoustic/hydro-acoustic methods may use the water in the pipes or the pipes themselves to transmit sound waves between transmitters and receivers. Each of these wireless communication methods enables the installation of new irrigation systems but also relatively low-cost, low-impact retrofitting of existing irrigation systems.

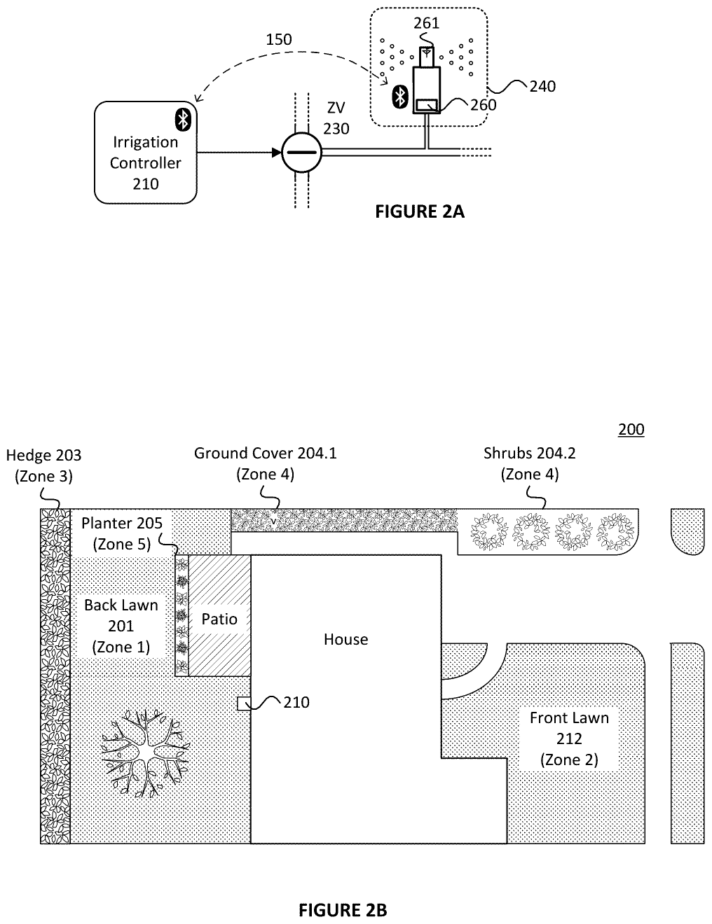

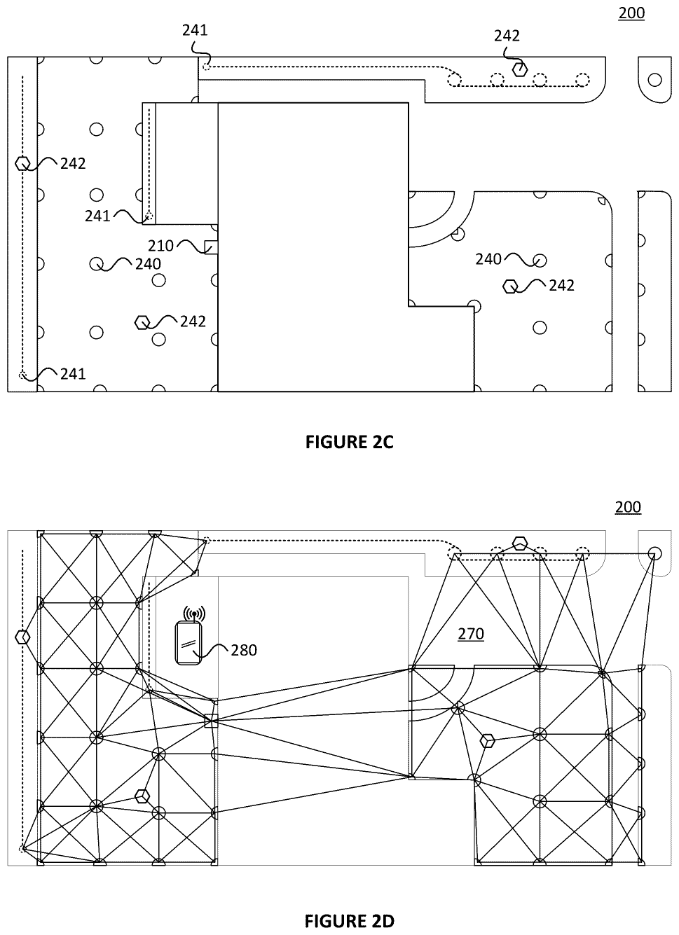

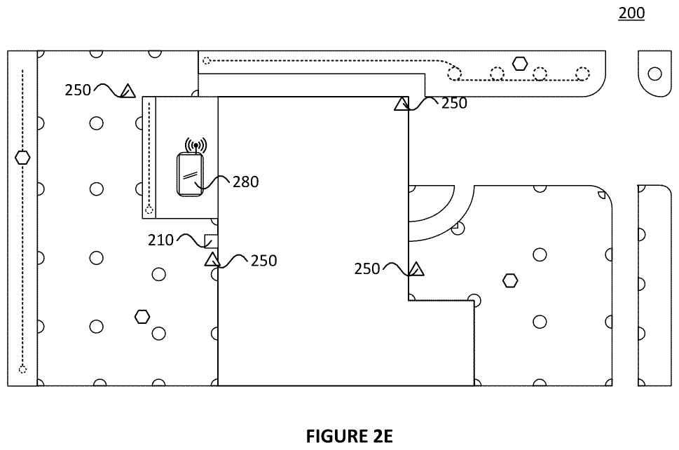

FIGS. 2A illustrates an embodiment of an RF communication pathways between an irrigation controller 210 and a sprinkler 240 (or other system element), as described above with regard to FIG. 1. An RF link 150 may be established between irrigation controller 210 and sprinkler 240. The RF link 150 may conform to any one of a number of wireless communication protocols, including Wi-Fi, Bluetooth, Zigbee, Ultra-wide Band (UWB), or the like. FIG. 2A illustrates a Bluetooth connection, but this is merely exemplary and should not be interpreted as limiting. Irrigation controller 210 may be configured to provide control signals to zone valve 230 and to sprinkler 240. Control signals provided to sprinkler 240 may be via RF link 150 to embedded electronics 260 within sprinkler 240 or placed outside but in close proximity sprinkler 240, to control operation of sprinkler 240 individually, rather than the entire zone through zone valve 230. While not specifically shown, similar a similar communication link between irrigation controller 210 and zone valve 230 may be present. Direct electrical connections between irrigation controller 210 and zone valve 230 may also be implemented.

For RF communication, a required antenna 261 may be disposed in or mounted on the pop-up portion of the sprinkler head, which exposes antenna 261 while the system operates. Antenna 261 may be mounted on the top of the sprinkler head or along the side, such that it has sufficient range to communicate with the irrigation controller (directly or through a mesh network). Antenna 261 may only be a few square-millimeters in area, making it possible to place the antenna where it can broadcast and receive signals from the irrigation controller 210. Using RF communication methods, such as Bluetooth, Zigbee, Wi-Fi, or UWB may allow mobile devices (e.g., smartphones or tablets) to assist in the installation process as sprinklers are onboarded or provisioned onto a network included irrigation controller 210.

In another embodiment, antenna 261 may be disposed outside a housing of the sprinkler, reducing the overall physical space within the housing and removing space limitations of antenna 261 itself, which may increase the communication distance. Disposing antenna 261 on the outside of the housing of the sprinkler also removes the constrains of the physical dimensions inside the sprinkler or the pipe. Communication and control circuitry may similarly be disposed outside the sprinkler housing, leaving only the required energy harvesting components (discussed below) inside the sprinkler housing.

FIG. 2B-D illustrates a residential irrigation plan and system 200 that may be configured to use an irrigation controller and smart sprinkler like those discussed above with regard to FIGS. 1 and 2A. A residential layout 200 may include a number of areas which may be assigned to zones, as needed. These areas may include a back lawn 201 (zone 1), a front lawn 212 (zone 2), a hedge 203 (zone 3), ground cover 204.1 and shrubs 204.2 (zone 4), and a planter 205 (zone 5). While five zones are described, one of ordinary skill in the art would understand that more or fewer zones may be implemented, based on the layout of the residential landscape. Further, a single zone from FIG. 2B may be split into multiple zones or multiple zones combined. In one embodiment, zones may be configured to match the anticipated water usage for landscape design elements within the zone. Such macroscopic configuration may provide first-pass optimization which may be improved considerably by node-specific configuration and control, as is described herein. Residential irrigation plan and system 200 may also include irrigation controller 210 to provide control signals to irrigation elements, such as sprinklers, drip systems, and the like, as discussed above with regard to FIG. 1. Irrigation controller 210 may also receive data and other information from irrigation elements and interface devices (such as computers, mobile phones, or other handheld devices).

FIG. 2C illustrates a potential layout of residential irrigation plan and system 200 including sprinklers 240, drip systems 241, and sensors 242. Sprinklers 240 may be distributed throughout the yard to provide irrigation to the lawn and trees. While not shown, sprinklers (and not drip systems) may also provide irrigation to shrubs and other plants. But for the purposes of explanation, and ease of description only, hedge 203, ground cover 204.1, shrubs 204.2, and planter 205 are serviced by drip systems 241. Sensors 242 may be placed throughout the yard to sense and provide information related to temperature, moisture, humidity and other characteristics that may help determine how much water to provide to various areas. While one four sensors are shown, one or ordinary skill in the art would understand that additional sensors may be placed throughout residential irrigation plan and system 200 and, in some embodiments, may be integrated into sprinklers 242. Sprinklers 240, drip systems 241, sensors, 242, and other elements, such as dedicated valves, repeaters, and the like may be referred to as in-line elements. In one embodiment, “in-line elements” relates to elements being connected to pipes such that water pressure (and power) is provided via the movement of water.

As sprinklers 240, drip systems 241, sensors 242 and other in-line elements may be distributed at great distances from an AC mains power source, or at least at distances that make direct mains power impractical, local power and power generation may be used. It may also be desirable for a sprinkler or other irrigation system component not to require a discrete battery. In such situations, energy harvesting may provide the necessary power for communication and control circuitry at the sprinkler, drip system, or zone valve end of an irrigation system. Energy harvesting embodiments are described in more detail below. In some embodiments it may be that an irrigation controller to be powered by a mains supply, so energy harvesting is not necessary.

Irrigation system elements, such as sprinklers 240, drip systems 241, and sensors 242 may also operate at relatively low power (as they are not coupled to an AC mains power source); low power techniques may be employed. In one embodiment, irrigations system elements may be in a low power state until they receive an RF signal, at which time they power up and provide full functionality. In the case where wake-on-signal or wake-on-pulse is used as a power-saving technique, a wake signal may cause the receiver to activate additional functions of the receiver. In this embodiment, only the receive circuitry may be active. But once a wake signal is received, functions associated with the control, processing, and signal transmission of a sprinkler (or zone valve), including secondary functions such as moisture detection, humidity sensing, and temperature measurement, may be activated. In this way, signal processing may only occur and be enabled when signals are sent from the irrigation controller. In still another embodiment, when power is provided to the irrigation system element by the water in pipes, the full-power state may be entered.

FIG. 2D illustrates a wireless mesh network 270 that may be used for communication between irrigation controller 210 and sprinklers 240, drip systems 241, and sensors 242. Mesh network 270 may be used to provide communication between irrigation controller and all nodes of residential irrigation plan and system 200. Furthermore, while a Bluetooth mesh network is described, in the context of FIG. 2A, one or ordinary skill in the art would understand that other wireless protocols, such as Wi-Fi (WLAN), Zigbee, or ultra-wideband (UWB) may also be used. Furthermore, mobile device 280 may also be in operative communication with irrigation controller 210 or with sprinklers 240, drip systems 241, or sensors 242, either directly or through mesh network 270. While note shown, dedicated repeater nodes may also be implemented to extend signals and create a more reliable mesh network, especially when there are large sections of residential irrigation plan and system 200 that do not have irrigation elements or are at distances that are too great to reach by irrigation controller 210 without additional communication elements to bridge the distance. Mobile device 280 may be configured to receive data and provide control signals directly to irrigation system elements or it may provide control signals to irrigation controller 210, which are then passed to irrigation system elements through mesh network 270.

FIG. 2E illustrates an embodiment for wireless communication that uses at least one hub 250 to relay signals from irrigation controller 210 to sprinklers and other irrigation system elements. Hubs 250 may communicate with sprinklers and other irrigation system elements via a first protocol and with the irrigation controller 210 via second communication protocol. In another embodiment, hubs 250 may communication with sprinklers and other irrigation system elements and with irrigation controller 210 via the same protocol. In still another embodiment, hubs 250 may communicate with mobile device 280 directly or through irrigation controller 210. In still another embodiment, mobile device 280 may operate as a hub as it moves through the irrigation system coverage area, providing communication to sprinklers and irrigations system elements that are within range.

In one embodiment, hubs 250 may provide additional processing of data received from either the sprinklers or other irrigation system elements or the irrigation controller 210. In this embodiment, hubs 250 may provide control signals to a subset of the sprinklers and other irrigation system elements and then provide status to the irrigation controller 210. In another embodiment, hubs 250 may operate as repeaters, the function of which is to pass wireless signals from one node to another without any additional processing. In this embodiment, repeaters may function merely as pass-through devices.

While the embodiments of FIGS. 2B-E are directed to residential irrigation plan and system 200, one of ordinary skill in the art would understand that the same principles may be applied to agricultural irrigation or other large-scale systems that require irrigation (such as industrial facilities, parks, golf courses, municipal green spaces, schools, etc.). Individually controllable sprinklers, drip systems, sensors, valves, and other in-line elements may enable efficient water use at much larger scales than in residential landscaping. And the detection of faults in such systems may provide much greater savings and impact on water use and the environment. Additionally, in-line elements may not be buried, enabling much easier replacement or repair upon fault detection. Furthermore, systems where in-line elements are not buried or are not very close to the ground may have better RF signaling as antennas, through small, may be enlarged to improve communication range.

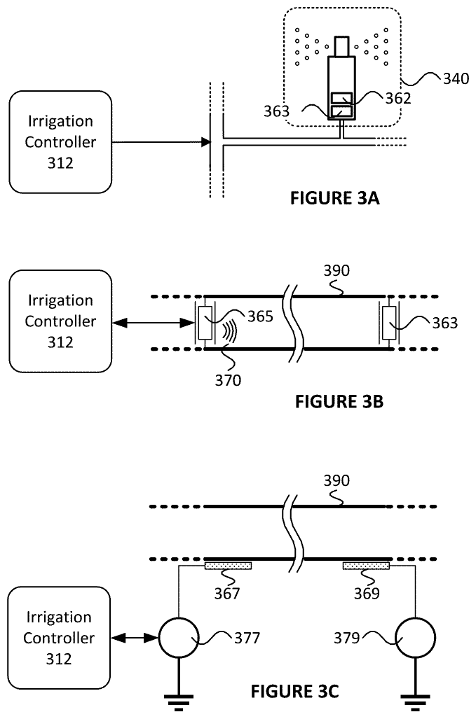

FIG. 3A illustrates an embodiment in which control signals are provided from irrigation controller 312 to sprinkler 340 through the water in the pipes in hydro-acoustic or galvanic connection. Embedded electronics 362 within sprinkler 342 may be configured to receive signals with communication hardware 363, such as audio or electrical signals that are passed through the water in the pipes between irrigation controller 312 and sprinkler 342.

In a hydro-acoustic communication system, the modulation or sound waves may be used to transmit information. Frequency-shift-keying (FSK) is one example of such modulation. Those of ordinary skill in the art would understand that other modulation techniques and enhancements, such as error correction encoded schemes, may also be used. For FSK implementations, frequencies that conduct well in water may be chosen (e.g., 10-1000 kHz). Higher frequencies may be used to allow for faster communication and physically smaller components. However, higher frequencies may suffer greater absorption and may not travel the necessary distances, especially for larger irrigation systems. As an irrigation system such as the one described herein is not required to have fast data communication rates and as robustness, reliability, power consumption, and cost are far greater drivers of system success, lower communication frequencies may be desired.

To transmit sound (and therefore signals) through water-filled pipes, an irrigation controller, zone valves, and sprinklers may utilize transducers. FIG. 3C illustrates an embodiment of a communication pathway used in FIG. 3B that includes a first sound transducer 365 and second sound transducer 363 for sending and receiving control signals to and from irrigation controller 312 and sprinkler 342. Sound transducer 365 may be coupled to irrigation controller and may receive signals from irrigation controller that are converted into sound waves 370. Sound waves 370 may be sent through the water inside pipe 390 to sound transducer 363. Sound transducer 363 may convert sound waves 370 back into electrical signals for interpretation by embedded circuitry in the sprinkler (as described in FIG. 3B). In an embodiment, sound transducer 363 may provide signals back to irrigation controller 312 by creating sound waves that are received by sound transducer 365. In still other embodiments, sound transducer 363 may be configured to provide control signals to other sprinklers in the system through water in pipe 390. In this way, sprinkler 342 may operate as a range extender for signals from irrigation controller 312.

Sound transducers 363 and 365 may be piezo-electric units capable of translating electrical signals into physical pressure (and back). Piezo-electric units are inexpensive, mechanically robust, and well-suited to underwater sound generation. Sound transducer 365 may be coupled to an irrigation pipe, such as pipe 390, at an appropriate location. Appropriate locations may include a non-waterflow restricting locations in a zone-specific pipe or the main water pipe leading to all the zones. In this embodiment, sound waves carrying control signals may travel through water into whichever zone is to be activated by the respective valve (and the associated control signals).

In one embodiment, repeater modules may be installed throughout the irrigation system to ensure that signals from an irrigation controller (such as irrigation controller 110 of FIG. 1) propagate to receivers (either zone valves or sprinklers) that are distant from irrigation controller and the main transducer. In this embodiment, hysteresis in control signals may prevent sprinklers or zone valves from executing commands twice when they are received from both the irrigation controller 312 and at least one repeater module. In still another embodiment, standard collision avoidance methods may be used.

In a system using hydro-acoustic communication, once water has filled the pipes, all sprinklers, valves, and other transmitters/receivers may be reachable by irrigation controller 312. Furthermore, once sprinklers begin to operate and water moves past energy harvesting elements, transmitters/receivers in the valves and sprinklers may be powered and may enable individual control.

In one embodiment, acoustic receivers in zone valves and sprinklers may be inexpensive electret microphones with appropriate water protection. Acoustic receivers may also be simple hydrophones (underwater microphones). Hydrophones may be constructed from piezo-electric material, such as a piezo disc. Receivers may also include micro-power frequency decoders. Such acoustic receivers, with appropriate an associated energy harvesting circuitry (discussed below) could remain “always on” once water is flowing in the pipes. In another embodiment, acoustic receivers may implement power saving techniques, such as sleep timers, wake-on-signal, or other techniques.

Sound transducers 363 and 365 may be disposed not inside the water pipe, but on the outside. Sound may also be carried not through the water, but through the pipes themselves. Water pipes may be constructed from relatively strong material, such as ABS or PVC plastic and include solid sealed junctions between segments. The construction of an irrigation system may create a good mechanical conduit for propagating sound waves along the physical pipes. In this embodiment, control signals that are transmitted via sound waves would not be reliant on water actually being in the pipes to send control signals.

Piezo-electric transducers may be mounted to the pipes of the irrigation system by adhering an appropriate transducer to a pipe header. The transducer may transmit and receive signals, converting electrical signals into pressure (sound) waves and converting pressure (sound) waves back into electrical signals. In one embodiment, high levels of sound energy may be produced by choosing sound frequencies near the natural resonance frequency of the transducer system. Natural resonant frequencies may be determined via a frequency sweep. It may be manual (triggered by a user command) or automatic. The frequency sweep may be completed once during installation, one power-up, at intervals, or during post-installation calibration. In various embodiments, frequency sweeps may be completed at regular intervals to adjust to changing conditions or if communication is found to have fault conditions indicative of the selected frequency no longer being appropriate for the system. By choosing frequencies near the natural resonance frequency of the transducer system, power requirements, especially for sprinkler side communication and processing circuitry can be reduced.

FIG. 3C illustrates and embodiment of a communication pathway used in FIG. 3B that includes a first electrical contact 367 and a second electrical contact 369 for sending and receiving control signals to and from irrigation controller 312 and sprinkler 342. First and second electrical contacts 367 and 369 may be coupled to electrical signal sources 377 and 378, respectively. Electrical signal sources 377 and 379 may provide the actual electrical stimuli that are sent through water in pipe 390. Irrigation controller 312 may provide control signals to electrical signal sources 377 and 379 and to enable communication between the electrical contacts. Embedded circuitry in sprinkler 340 may convert the received electrical signals received on electrical contact 369 through an electrical signal receiver into the appropriate control signals.

As previously discussed it may be desirable for individual sprinklers to turn off their own water flow or have the ability to turn off water flow based on control signals from an irrigation controller like irrigation controller 110 of FIG. 1. Detection of faults (too much or too little water) or soil conditions (such as temperature or moisture) may indicate that water flow to a sprinkler or to an area serviced by that sprinkler should be reduced or terminated. In these circumstances, an embedded shut-off valve may be implemented.

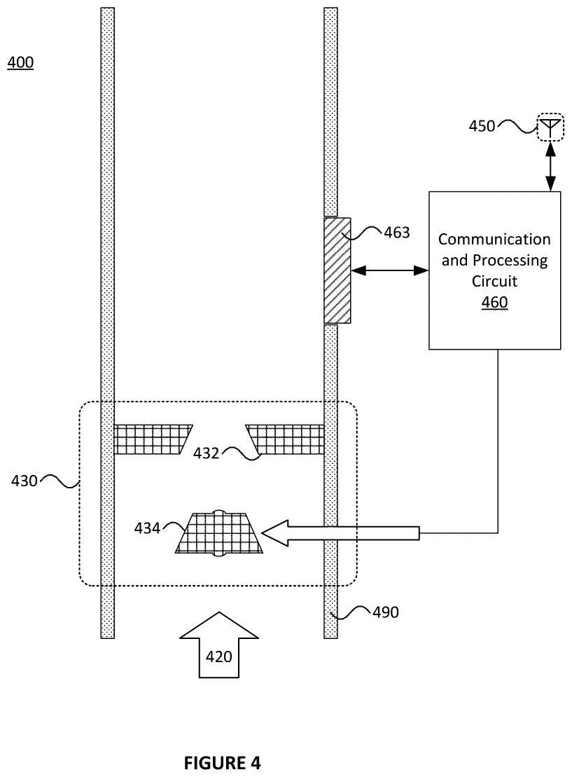

FIG. 4 illustrates an embodiment of a control and communication mechanism 400 for a smart sprinkler, similar to those described with regard to FIGS. 1 and 2A, and 3A-C, above. A valve 430 may include a valve seat 432 and a diaphragm 434 which may be released into an opening in valve seat 432 to close valve 430 based on the water pressure in the direction 420 of water flow. In one embodiment, a shut-off valve as illustrated with valve 430 may be constructed to shut off water (and keep it shut off), but not turn it on. Valve 430 may require just enough energy to direct water flow to the closing mechanism, letting the water pressure in the pipe 490 shut off water flow to downstream elements Downstream elements may be additional sprinklers or sensors when the valve is implemented in a zone valve. Downstream elements may merely be the nozzle of the specific smart sprinkler. Upon water pressure on the upstream side of valve 430 being reduced or removed, from the closing of an upstream valve, valve 430 may be opened (via a spring mechanism) so that normal operation may resume when water is returned to the pipe.

Communication and processing circuit 460 may be coupled to a communication element 463 disposed on or within pipe 490 or antenna 450 disposed such that RF signals may propagate to receivers (such as at the tip of the sprinkler head), as described above with regard to FIGS. 2A and 3A-C.

While communication and processing circuit 460 may receive instructions from a host controller, such as irrigation controller 110 of FIG. 1 to activate valve 430, it may also be possible for communication and control circuit 460 to activate shut-off control autonomously (without instruction from irrigation controller 110) based on measured conditions within or around a smart sprinkler. In one embodiment, measured conditions may include excess water flow, unexpected or increased moisture content in the soil, or the like.

In another embodiment, valve 430 may be disposed within a junction or in a location that is not directly linked to a specific sprinkler. This may provide the ability to shut off an entire zone or an area with minimal power requirements.

As smart sprinklers that are distributed through an irrigation system will require power for communication and control operations, including the turning on/off of water through the sprinkler and for the receiving, processing, and returning of signals to an irrigation controller, it is necessary to provide some mechanism to power that which requires power. Providing a wired power source, while possible, is not preferred as the installation and maintenance requirements of such a system would be prohibitive. Rather, the ability of sprinklers (or other irrigation system elements) to generate their own power is preferred. Not only would installation be easier and less costly, but maintenance and replacement becomes simpler. Additionally, an irrigation system with modular and individual powering of distributed elements allows for easier changes to the system design and for additions to the irrigation system without a redesign or reinstallation. As water is provided to each of the sprinklers and in-line elements during operation of the irrigation system, that water (and its flow) may be utilized to provide power to the required components of a smart sprinkler or in-line element.

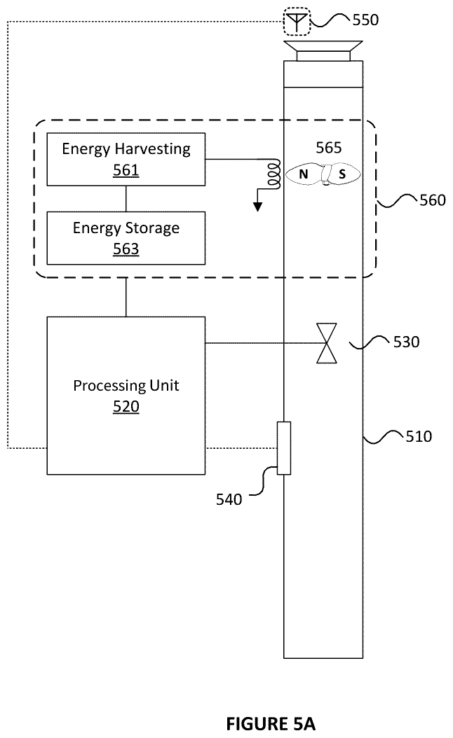

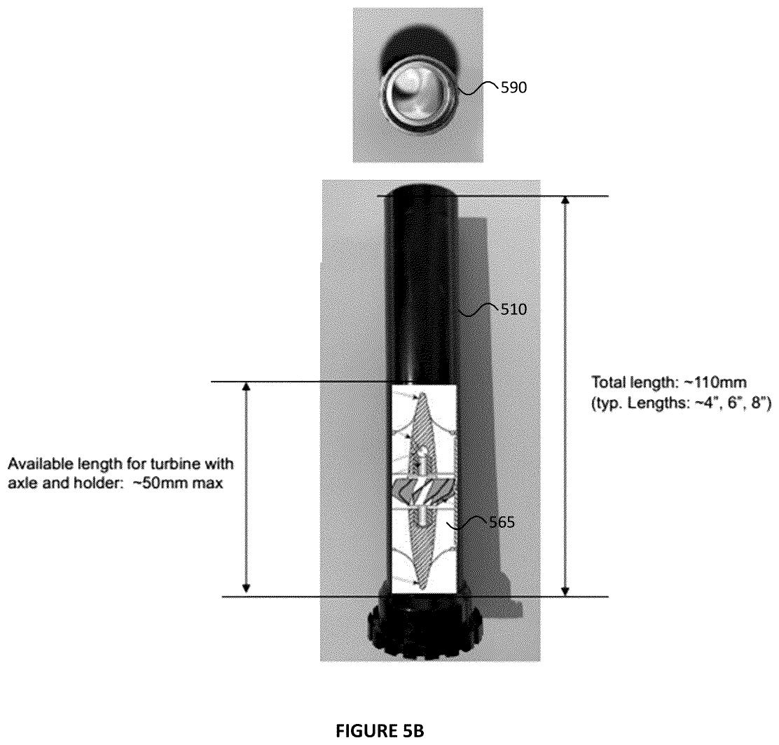

FIG. 5A illustrates one embodiment of a sprinkler head 510 that includes the various communication and control elements described above with regard to FIGS. 1-4. Sprinkler head or sprinkler body 510 may include a processing unit 520 for receiving signals from an irrigation controller (such as irrigation controller 110 of FIG. 1) and for providing control signals to valve 530 as described above with regard to FIGS. 2A-D. Signals from the irrigation controller may be received by speaker/microphone or galvanic/acoustic transceiver 540. In an RF embodiment, signals from the irrigation controller may be received on antenna 550. Control unit 520 may be coupled to valve 530 for providing signals to open and/or close valve to allow/disallow water to move through the sprinkler head (as described above with regard to FIG. 3). Sprinkler head 510 may also include energy harvesting hardware 560 including a turbine or impeller 565, energy harvesting control circuitry 561, and energy storage 563. Energy harvesting hardware 560 may be coupled to control unit 520 for providing power to processing unit 520 as well as receiving control signals for operation of energy harvesting hardware 560.

FIG. 5B illustrates a conceptual implementation of sprinkler head 510 with an impeller (turbine) 565 placed inside a housing (pipe) for a smart sprinkler assembly, as described with regard to FIG. 5A. A housing 590 may have an outer diameter of 21 mm and thickness of 3 mm. This leaves approximately 15 mm for the in-housing energy harvesting hardware, including impeller 565. Additionally, the in-housing distance for turbine or impeller 565 may be approximately 50 mm, meaning that the energy harvesting hardware must fit in a column that is 15 mm in diameter and 50 mm in length. The remaining area of the total length of the housing may be used for valve control and communication and control circuitry. Specific dimensions of sprinkler head 510 are merely demonstrative and are not intended to limit the solution to such measurement. One of ordinary skill in the art would understand that larger or smaller pipes may be used, allowing for or necessitating different sizes for system elements. In various embodiments, different sprinklers, drip systems, zone valves, measurement devices, or other system elements may have different dimensions which may be determined based on system requirements.

As sprinklers, drip systems, and zone valves may be distributed at great distances from a mains power source, or at least at distances that make direct mains power impractical, local power and power generation may be used. It may also be desirable for a sprinkler or other irrigation system component not to require a discrete battery. In such situations, energy harvesting may provide the necessary power for communication and processing circuitry at the sprinkler, drip system, or zone valve end of an irrigation system. It may be typical for an irrigation controller to be powered by a mains supply, so energy harvesting is not necessary. Energy harvesting apparati and circuitry may be disposed such that power is generated for each individual element of an irrigation system, reducing or eliminating the need for wires or other means for distributing power. Energy harvesting elements may be disposed in the base of a sprinkler (or in a junction to a drip system), as shown in FIGS. 4 and 5, or within in-line modules, such as zone valves and water flow meters (especially for drip systems). Energy harvesting elements may function as a small power generator, including a small impeller/waterwheel unit inside the water pipe or a sprinkler housing. A permanent magnet may be mounted within, on, or in impeller or waterwheel blades (or mounted on a separate assembly and coupled to impeller/waterwheel). An electric coil can then be mounted proximate to the moving permanent magnet to convert a change in the magnetic field from the rotating permanent magnet inside the pipe or housing into electrical energy.

Energy harvesting apparati may be used to measure water flow rate as well. As water pressure, and flow rate, will cause a turbine to rotate faster or slower, the rotations speed is an indicator of flow rate through a sprinkler, drip system, or in-line module. Rotational frequency may be detected inside the energy harvester apparati by measuring the time between polarity alternations from the energy harvester. In another embodiment, the charge rate on an energy storage module may be measured, the charge rate indicative of the speed of the impeller and the flow rate of water in the pipe or through the sprinkler.

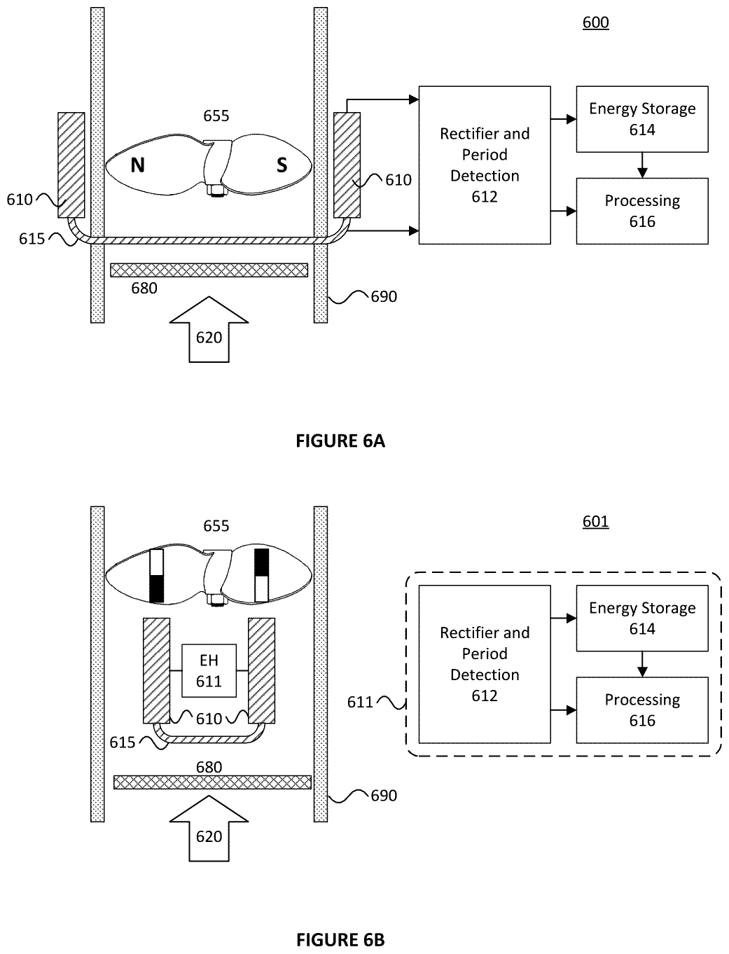

FIG. 6A illustrates an embodiment of energy harvesting hardware 600 disposed in and around pipe 690. A filter 680 may be disposed inside pipe 690 proximate to turbine 655 (also referred to as an impeller, herein). Filter 680 may ensure that impurities in the water do not negatively impact operation of turbine 655. Turbine 655 may include a permanent magnet (denoted by “N” and “S”) on or in the turbine blades. The permanent magnet may induce a current on inductor coils 610, which are connected by yoke 615 and are coupled to Rectifier and Period Detection module 612. Rectifier and period detection module 612 may be coupled to an energy storage 614 and a processing module 616. Energy storage 614 may be a battery, a super-cap, or any other suitable element for storing energy to be provided to processing module 616 and to processing circuitry for communication and control of the sprinkler. In one embodiment, energy stored in energy storage 614 may be used to turn a local valve on, thus releasing water flow through the pipe and enabling energy harvesting hardware to work. While the water flows through the pipe, energy may be harvested and the energy storage resupplied (either by charging a batter or a super-cap).

FIG. 6B illustrates an embodiment of energy harvesting hardware 601 disposed inside pipe 690. As with FIG. 6A, a filter 680 may be disposed inside pipe 690 proximate to turbine 655. Filter 680 may ensure that impurities in the water do not negatively impact operation of turbine 655. Turbine 655 may include a number of permanent magnets on the turbine blades. Inductive coils 610 may be connected by yoke 615. Inductive coils 610 may be disposed inside pipe 690 and coupled to energy harvesting circuitry (EH) 611. The permanent magnets on turbine 655 may induce a current on inductor 610, which is coupled to Rectifier and Period Detection module 612. Rectifier and period detection module 612 may be coupled to an energy storage 614 and a processing module 616. Energy storage 614 may be a battery, a super-cap, or any other suitable element for storing energy to be provided to processing module 616 and to control circuitry for communication and control of the sprinkler. In one embodiment, energy stored in energy storage 614 may be used to turn a local valve on, thus releasing water flow through the pipe and enabling energy harvesting hardware to work. While the water flows through the pipe, energy may be harvested and the energy storage resupplied (either by charging a battery or a super-cap).

As discussed with regard to FIGS. 1 and 2A, and 3A-C, energy storage 614 may be used to provide power to communication circuitry so that data may be communicated back to irrigation controller 110 of FIG. 1. As sprinklers, drip systems, and in-line modules are distributed throughout the irrigation system, they may receive information on surrounding conditions and provide that information back to irrigation controller 110 through communication circuitry using power from energy storage 614. In one embodiment, sprinklers, drip systems, and in-line modules may communicate the status of energy storage 614. In this embodiment, irrigation controller may turn on water to specific zones to enable power generation through energy harvesting hardware 600 when power levels on energy storage 614 reach a minimum threshold. In this way, an irrigation system can ensure that all of the constituent elements have enough power to operate when needed.

Such a situation may arise if there are long periods of little or no watering due to environmental conditions (e.g., it has been raining). In this scenario, sprinklers, drip systems, or in-line modules may be measuring and communicating information without periodic recharging through energy harvesting hardware. If the power level in energy storage 614 is too low for the devices to receive signals and to take actions based on those signals, the system may cease proper operations. By periodically turning on the water enough to recharge energy storage 614, such failure conditions may be avoided.

In still another embodiment, external charging connections may be disposed so that upon a low-power condition severe enough to prevent proper operation of energy harvesting hardware 600 or 601, external power may be supplied. Such situations are not ideal, but may need to be contemplated for corner case operation of an irrigation system. In this way, it would not be necessary to remove a sprinkler, drip system, or in-line module control unit to reestablish power to the device.

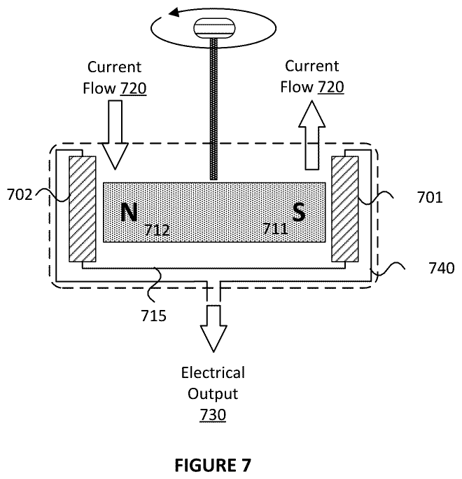

FIG. 7 illustrates operation of the turbine to create a current for providing power to control and communication circuitry as well as for providing power to an energy storage module. This embodiment may be referred to as a “magnetic yoke”, whereby a pair of magnetic coils 701 and 702, which are magnetically coupled via a yoke 715, are mounted in close proximity to magnets 711 and 712 on or in the impeller (or turbine). These coils may form a transaxial yoke, as shown in FIG. 6B. As a turbine including the permanent magnet spins, its proximity to inductive elements 701 and 702 induces a current 720 that is routed to electrical output 730 via leads 740. The alternating magnetic field is converted to electrical energy. Electrical energy may be stored in an energy storage unit, such as a capacitor, super-cap, or battery. This stored energy may be used to provide power to local electronics for communication and control, including control of the sprinkler on in-line valve mechanisms for turning on water (when energy harvesting circuitry is inactive).

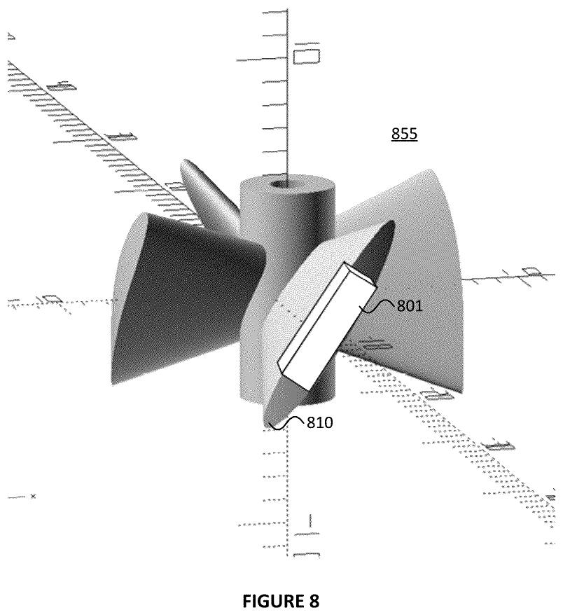

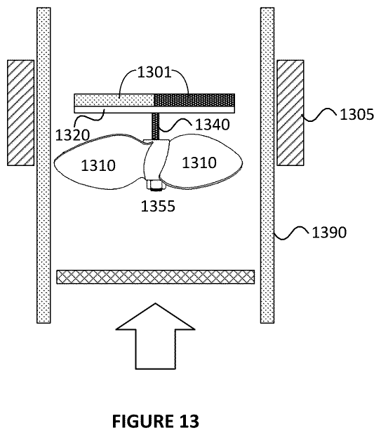

FIGS. 8-13 illustrate various embodiments of impellers which may be disposed within a pipe or sprinkler head for generation of power in an energy harvesting application like energy harvesting hardware 560 (of FIG. 5A). A normal power turbine may use an impeller that is coupled to an electric generator, but where the water flow is redirected or diverted away from the generator. This keeps the generator dry. In the proposed embodiments, the impeller blades themselves are magnetic, have permanent magnets places on them, or are attached to a magnetic assembly that is placed inside the housing (or pipe). Electric coils placed on the outside of a housing (or pipe) can then convert magnetic energy into electrical energy. Diversion of water is not required, allowing for smaller and more scalable power generation. Such an apparatus is described in greater detail in FIG. 13 below.

FIG. 8 illustrates one embodiment of an impeller 855 with a permanent magnet 801 placed in or on one of the blades 810. Another permanent magnet may be placed on the opposing blade, which enhances changes in magnetic fields on coils inside or outside the housing. The changes in magnetic fields may be converted into electrical energy. While four blades are illustrated on impeller 855 and two magnets are described, one of ordinary skill in the art would understand that more or fewer impeller blades and magnets may be implemented to the same purpose.

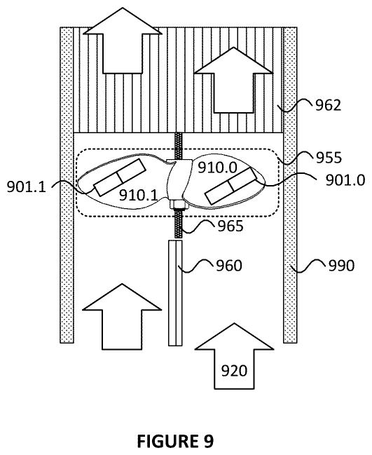

FIG. 9 illustrates one embodiment of a turbine inside a pipe 990 for power generation in energy harvesting. Turbine 955 may include a number of permanent magnets 901.0 and 901.1 on its blades 910.0 and 910.1. Water may flow through the pipe 990 according to the direction of flow 920. So that flow is not impeded by turbine 955 more than necessary, a plurality of supports 960 and 962 may be used on either side of axle 965. Support 960 may be disposed on one side of turbine 955 and provide a cross-section to pipe 990. Support 962 may be disposed on a second side of turbine 955 and provide a second cross-section to pipe 990. The first and second cross-sections may be perpendicular. They may also be parallel. They may also be oriented in some other configuration.

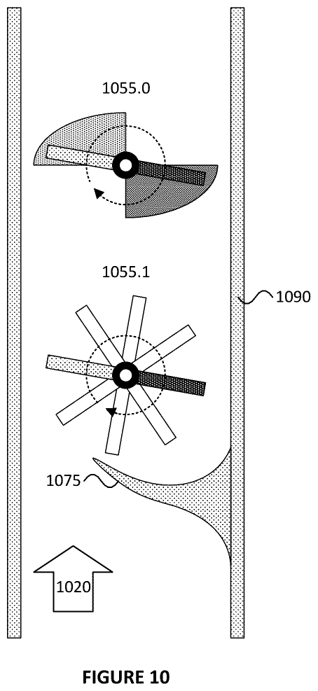

Since a minimum water flow is required to overcome the magnetic “drag” of a generator, it may be desirable to minimize the amount of water flow required to start rotation. FIG. 10 illustrates embodiments of a turbines 1055.0 or 1055.1 placed inside a pipe 1090 that permits water flow 1020 to move the turbine that is not positioned radially from the center of the pipe 1090. Turbine 1055.0 may include concave blades that catch water from a first direction and let it pass over in the other. For this turbine, the flow of water will have increased flow rate as the resistance of the blades in one direction is greater than the other. Turbine 1055.1 may use uniform blades, but include a water guide 1075 to force water to one side of pipe 1090, thus increasing flow rate and providing force on only one side of turbine 1055.1. Turbine 1055.1 may spin in only one direction as the force experienced by the blades on one side is greater than the other.

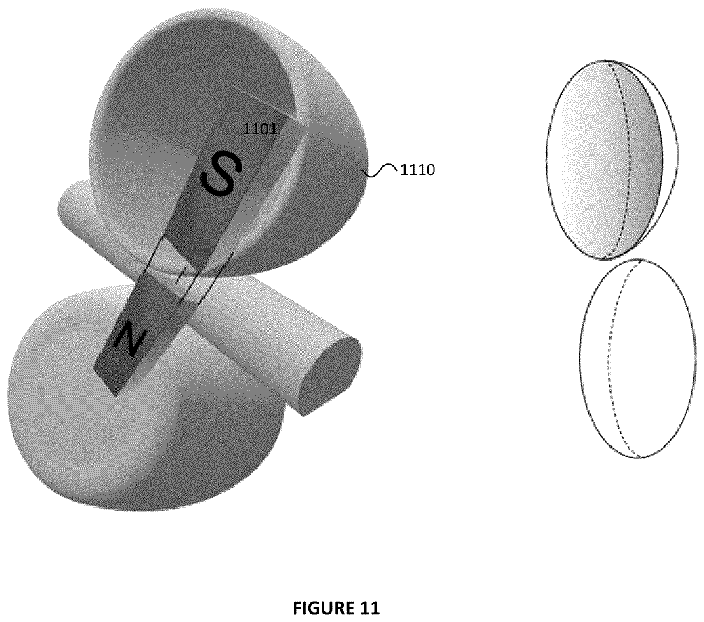

FIG. 11 illustrates another embodiment of cup-shaped impeller blades 1110 with permanent magnets 1101 installed thereon. As the impeller blades 1110 are cup-shaped, they will experience greater force from water inside the housing (or pipe) from a certain direction, forcing them to spin.

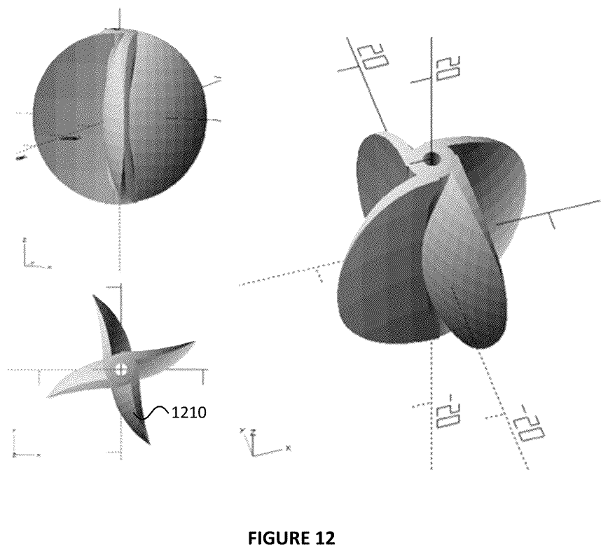

FIG. 12 illustrates still another embodiment of impeller blades 1210 that may be used with the embodiment of turbine 1055.1. Slight concavity in impeller blades 1210 coupled with a water guide 1075 (see FIG. 10) may create the desired rotation using lower total water pressure.

FIG. 13 illustrates an embodiment of a turbine 1355 within a pipe 1390, wherein the permanent magnets 1301 are not disposed directly on the blades 1310 but are attached to another element 1320 on the axle 1340 of the turbine 1355. Permanent magnet 1301 interacts with inductor coils 1305 of an energy harvesting module as described with regard to FIGS. 6 and 7 above.

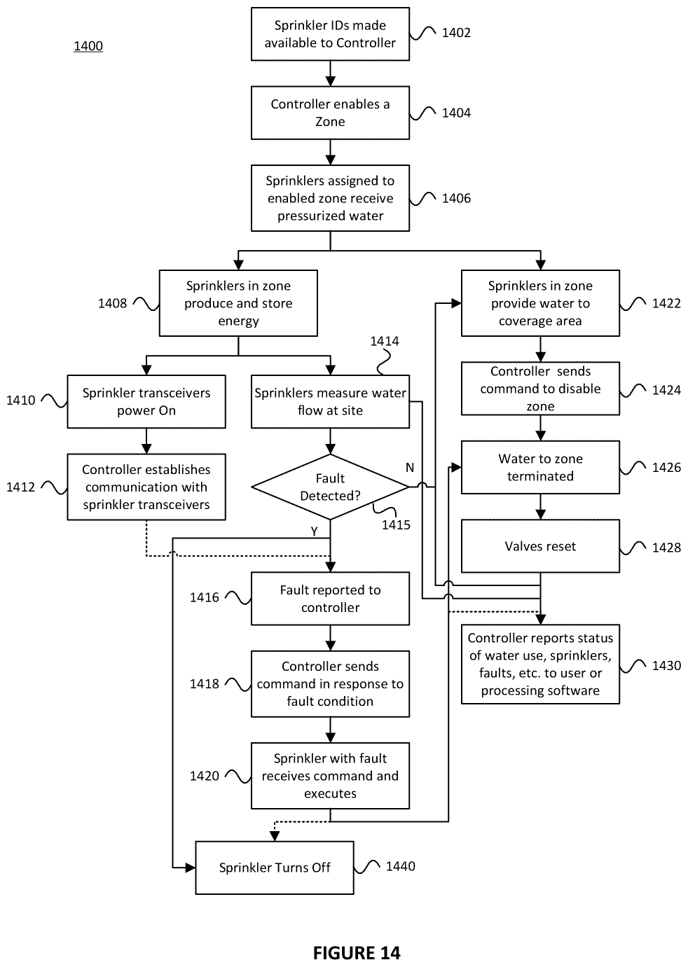

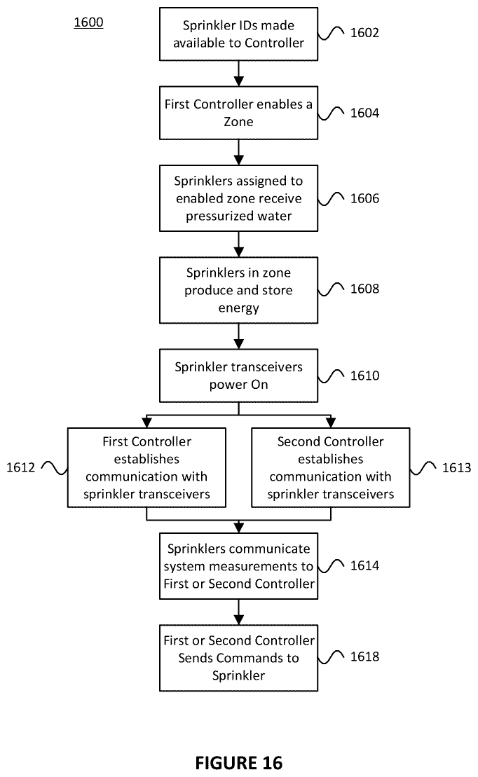

FIG. 14 illustrates a method 1400 for operation of a smart sprinkler (such as sprinkler 240) in an irrigation system (such as residential irrigation plan and system 200). While FIG. 14 references “sprinklers”, one of ordinary skill in the art would understand that sprinklers, drip systems, measurement devices, valves, repeaters or other in-line elements may be used. “Sprinkler” is merely for ease of description. Sprinkler IDs may be made available to controller (such as irrigation controller 210) in step 1402. Making sprinkler IDs available may be through standard onboarding and authentication methods, whereby each sprinkler ID is stored in the irrigation controller memory for authentication during operation of an irrigation system. Sprinkler IDs may also be available to a second controller, such as a cell phone or other mobile device, as discussed in more detail in FIG. 16. Additionally, making sprinkler IDs available does not need to be done at power-up for every operation. Initial setup may be completed once during installation or periodically based on system requirements. Setup may also be reinitiated for specific sprinklers if units are replaced, repaired, or updated. An irrigation controller may enable a zone in step 1404, providing water through the pipes of the irrigation system. Zones may be enabled through a zone valve in operative communication with the irrigation controller. Communication between the irrigation controller and the zone valve may be wired or wireless, in various embodiments. In some embodiments, an RF link may be established between the zone valve and the irrigation controller as it is established between sprinklers, drip systems, sensors, or other in-line elements as described above. Once water is supplied to the pipes of a zone, sprinklers (or other irrigation system elements) may receive pressurized water in step 1406. While “sprinklers” are described with regard to method 1400, one or ordinary skill in the art would understand that other irrigation system elements, such as drip systems, sensors, in-line valves and in-line flow meters, and other components may also be controlled, as is well described above.

Once pressurized water is provided to sprinklers assigned to the enabled zone, the sprinklers in the zone may harvest and store energy according to the description herein in step 1408. With the harvested energy, the sprinklers may power on a transceiver in step 1410 and establish communication with the irrigation controller in step 1412. This established communication may be used to communicate sprinkler status, receive commands, or report faults, as described below.

Also once pressurized water is provide to sprinklers assigned to the enabled zone, the sprinklers may measure water flow at the site in step 1414. Sprinklers may measure the actual water flow in real time and transmit that data at certain intervals to the controller or upon request. Status of sprinklers may be communicated to the irrigation controller and reported to a user or processing software in step 1430. Sprinklers may compare the measured water flow to expected water flow and determine if a fault condition exists in step 1415. If a fault condition is detected, the condition may be reported to the controller in step 1416. In one embodiment, the sprinkler may also turn itself off based on the detected fault in step 1440. In another embodiment, the controller may process the received fault condition information and send a command back to the sprinkler in step 1418. The sprinkler with the fault condition may receive and execute the command in step 1420. The command from steps 1418 and 1420 may be to turn off the sprinkler, which may occur in step 1440. Fault conditions may include too much water flow or too little water flow, including no water flow at all. In one embodiment, a fault condition may be reported to the controller, but action to turn off the sprinkler or zone is not taken without user action with an interface, as discussed above in FIG. 2C. After a user initiates an action, the sprinkler may be turned off in step 1440 or the controller may turn off the entire zone in step 1424. One of ordinary skill in the art would understand that additional control pathways may be used, depending on system requirements.

If no connection is made with a sprinkler in a zone, this may be indicative of a fault in the irrigation system that is preventing water (and therefore power) from reaching the sprinkler. Irrigation controller can record this condition and take actions, such as shutting off the zone if a sprinkler is missing, indicating a break in the pipe to that sprinkler. A fault such as this may also lead to immediate communication of the fault condition to the user (owner or maintenance personnel), as shown in step 1430.

Once pressurized water is received by sprinklers in the enabled zone, water may be provided to the coverage area in step 1422. Water may continue to be provided to the coverage area in step 1422 if no fault is detected in step 1415. After a prescribed period (set by a user or as a general setting) the zone may be disabled in step 1424 and the water turned off in step 1426. The release of water pressure may reset (open) the valves in step 1428 at least as described above with regard to FIG. 4. The controller may be report status of water use, sprinkler operation, faults, etc. to a user or processing software in step 1430. While step 1430 is shown to be at the end of method 1400, one of ordinary skill in the art would understand that reporting status of water use, sprinklers, faults, etc. may be performed at any time during method 1400 and may also be continually performed. In particular the status of sprinklers and fault detection may be reported through interrupts from the controller to the user or processing software so that immediate action may be considered and/or taken.

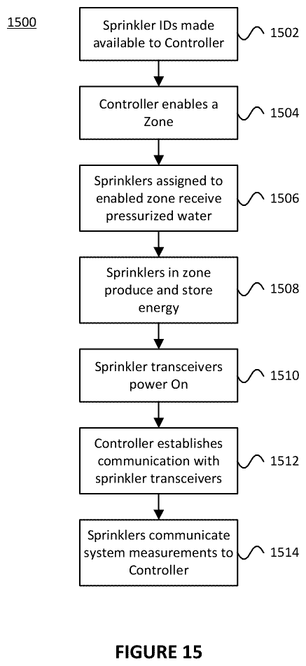

FIG. 15 illustrates a method 1500 for standard operation of a sprinkler or other in-line element. Method 1500 illustrates operation without fault detection, either because no fault is detected (such as in step 1515 of method 1500) or because fault detection is not enabled. Sprinkler IDs may be made available to controller (such as irrigation controller 210) in step 1502. Making sprinkler IDs available may be through standard onboarding and authentication methods, whereby each sprinkler ID is stored in the irrigation controller memory for authentication during operation of an irrigation system. Sprinkler IDs may also be available to a second controller, such as a cell phone or other mobile device, as discussed in more detail in FIG. 16. Additionally, making sprinkler IDs available does not need to be done at power-up for every operation. Initial setup may be completed once during installation or periodically based on system requirements. Setup may also be reinitiated for specific sprinklers if units are replaced, repaired, or updated. An irrigation controller may enable a zone in step 1504, providing water through the pipes of the irrigation system. Zones may be enabled through a zone valve in operative communication with the irrigation controller. Communication between the irrigation controller and the zone valve may be wired or wireless, in various embodiments. In some embodiments, an RF link may be established between the zone valve and the irrigation controller as it is established between sprinklers, drip systems, sensors, or other in-line elements as described above. Once water is supplied to the pipes of a zone, sprinklers (or other irrigation system elements) may receive pressurized water in step 1506.

Once pressurized water is provided to sprinklers assigned to the enabled zone, the sprinklers in the zone may harvest and store energy according to the description herein in step 1508. With the harvested energy, the sprinklers may power on a transceiver in step 1510 and establish communication with the irrigation controller in step 1512. This established communication may be used to communicate sprinkler status or receive commands. Sprinklers may communicate their status to the controller in step 1514.

FIG. 16 illustrates a method 1600 for sprinkler operation with multiple irrigation controllers. Method 1600 illustrates operation without fault detection, merely in the interest of clarity. However, one of ordinary skill in the art would understand that steps of method 14 may be implement with and between sprinklers and either a first or second controller. Sprinkler IDs may be made available to a controller (such as irrigation controller 210) in step 1602. The controller may be a first controller, such as the irrigation controller 210 or it may be a second controller, such as mobile device 280. Making sprinkler IDs available may be through standard onboarding and authentication methods, whereby each sprinkler ID is stored in the irrigation controller memory for authentication during operation of an irrigation system. Making sprinkler IDs available does not need to be done at power-up for every operation. Initial setup may be completed once during installation or periodically based on system requirements. Setup may also be reinitiated for specific sprinklers if units are replaced, repaired, or updated. An irrigation controller may enable a zone in step 1604, providing water through the pipes of the irrigation system. Zones may be enabled through a zone valve in operative communication with the irrigation controller. Communication between the irrigation controller and the zone valve may be wired or wireless, in various embodiments. In some embodiments, an RF link may be established between the zone valve and the irrigation controller as it is established between sprinklers, drip systems, sensors, or other in-line elements as described above. Once water is supplied to the pipes of a zone, sprinklers (or other irrigation system elements) may receive pressurized water in step 1606.

Once pressurized water is provided to sprinklers assigned to the enabled zone, the sprinklers in the zone may harvest and store energy according to the description herein in step 1508. With the harvested energy, the sprinklers may power on a transceiver in step 1610 and establish communication with a first irrigation controller in step 1612. Sprinklers may also establish communication with a second irrigation controller in step 1613. Communication with the second irrigation controller may be transitory as the second irrigation controller comes into operable range with each of the sprinklers. The second irrigation controller may also function as a controller to the sprinklers, but may also communicate to the first controller either on its own or as a repeater for sprinklers in the system. This established communication may be used to communicate sprinkler status or receive commands. Sprinklers may communicate their status to the controller in step 1514. First or second controller may provide commands to sprinklers in step 1618 as discussed above with regard to method 1400.

In one embodiment, certain sprinklers may be configured to turn off before others, either based on different conditions or based on timing or control signals from an irrigation controller. Such embodiments may be particularly useful for non-uniform landscaping and topography, such as slopes and flat areas with different drainage profiles. Other different conditions may be the types and number of plants in the coverage area for a given sprinkler. If the vegetation profile for a coverage area of a given sprinkler is changed, for example if large shrubs are replaced by smaller shrubs or if more drought tolerant vegetation replaces less drought tolerant vegetation, a specific sprinkler may be configured to terminate water flow before others in the same zone. This configuration may be sent to and programmed into the sprinkler in one embodiment. In another embodiment, the irrigation controller may store this configuration locally and send control signals to the sprinkler.

As used herein, the term “coupled to” means connected directly, or connected indirectly through one or more intervening components over PCB tracks/pads, switches, buses, hubs, trace lines, and/or programmable interconnects, as the case may be. Any of the signals provided through various PCB tracks/pads, switches, hubs, traces, and programmable interconnects may be time multiplexed with other signals and provided over one or more common or dedicated buses and/or signal traces. Each of the buses may alternatively include one or more single signal traces, and one or more signal traces may alternatively perform the function of a bus.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

Additionally, while “sprinkler” and “in-line element” are used separately in this forgoing specification, this distinction is not intended to be limiting. A sprinkler may be considered to be an in-line element. Furthermore, a sprinkler or other such in-line element may be placed at the terminus of an irrigation line such that water does not flow through a pipe past the sprinkler or in-line element, but at least flows through the sprinkler or in-line element sufficient to provide power through the energy harvesting hardware.

What is claimed is:

1. An irrigation system comprising:
an irrigation controller; and
a plurality of in-line elements in operative communication with the irrigation controller, the plurality of in-line elements comprising:
a communication circuit for receiving instructions from the irrigation controller,
an energy harvesting circuit for converting mechanical energy of water flowing through the plurality of sprinklers to electrical energy, and
a processing circuit for executing instructions received from the irrigation controller;
wherein the irrigation controller and the plurality of in-line elements form a communication network, through which signals are transmitted and received by the irrigation controller and the plurality of smart sprinklers.

2. The irrigation system of claim 1, wherein the plurality of in-line elements each comprises at least one energy storage module for providing power to the processing circuit and the communication circuit when the energy harvesting circuit is not active.

3. The irrigation system of claim 1, wherein the plurality of in-line elements includes a plurality of sprinklers.

4. The irrigation system of claim 1, wherein the plurality of in-line elements includes at least one measurement device.

5. The irrigation system of claim 1, wherein the plurality of in-line elements include at least one control junction, the control junction not configured to distribute water to an area via a nozzle.

6. An irrigation system comprising:
an irrigation controller;
a first in-line element in operative communication with the irrigation controller; and
a second in-line element in operative communication with the irrigation controller through the first in-line element,
wherein the first and second in-line elements each comprise:
a communication circuit for receiving instructions from the irrigation controller,
an energy harvesting circuit for converting mechanical energy of water flowing through the plurality of in-line elements to electrical energy, and
a processing circuit for executing instructions received from the irrigation controller.

7. The irrigation system of claim 6, wherein the first and second in-line elements are both sprinklers.

8. The irrigation system of claim 6, wherein at least one of the first and second in-line elements are devices for controlling the flow of water without the ability to distribute water to an irrigation area.

9. The irrigation system of claim 6, wherein the first in-line element and the second in-line element are in operative communication via a first protocol, and wherein the first in-line element and the irrigation controller are in operative communication via a second protocol.

10. The irrigation controller of claim 9, wherein the first and second protocols are the same.

11. The irrigation controller of claim 10, wherein the first in-line element and the second in-line element are in operative communication on a first band, and wherein the first in-line element and the irrigation controller are in operative communication on a second band.

12. An irrigation system comprising:
an irrigation controller;
a plurality of smart sprinklers comprising a first smart sprinkler and a second smart sprinkler, wherein the second smart sprinkler is outside a range at with direct communication between the irrigation controller and the second smart sprinkler is functional; and
at least one hub, the at least one hub for receiving instructions from the irrigation controller and providing the instructions to the second smart sprinkler, wherein the at least one repeater is located within operative communication range for the irrigation controller and the second smart sprinkler,
wherein the first and second smart sprinklers are configured to control the flow of water through the first and second smart sprinklers in response to instructions from the irrigation controller.

13. The irrigation system of claim 12, wherein communication between the at least one hub and the irrigation controller is via the same protocol as communication between the at least one hub and the second smart sprinkler.

14. The irrigation system of claim 13, wherein communication between the at least one hub and the irrigation controller is on a first band of a wireless medium and wherein communication between the at least one hub and the second smart sprinkler is on a second band of the medium.

15. The irrigation system of claim 12, wherein the at least one hub includes an energy harvesting circuit.

16. The irrigation system of claim 12, wherein the at least one hub is for managing communication traffic between the irrigation controller and at least the second smart sprinkler.

17. An irrigation system comprising:
an irrigation controller;
a plurality of smart sprinklers comprising a first smart sprinkler and a second smart sprinkler, wherein the second smart sprinkler is outside a range at with direct communication between the irrigation controller and the second smart sprinkler is functional; and
at least one repeater, the at least one repeater for receiving instructions from the irrigation controller and providing the instructions to the second smart sprinkler, wherein the at least one repeater is located within operative communication range for the irrigation controller and the second smart sprinkler,
wherein the first and second smart sprinklers are configured to control the flow of water through the first and second smart sprinklers in response to instructions from the irrigation controller.

19. The irrigation system of claim 17, wherein communication between the at least one repeater and the irrigation controller is via the same protocol as communication between the at least one repeater and the second smart sprinkler.

19. The irrigation system of claim 17, wherein communication between the at least one repeater and the irrigation controller is on a first band of a wireless medium and wherein communication between the at least one hub and the second smart sprinkler is on a second band of the medium.

20. The irrigation system of claim 17, wherein the at least one repeater is for passing signals from the irrigation controller to the second smart sprinkler.
